(19) United States
(12) Patent Application Publication
(10) Pub. No.: US 2011/0279733 A1
(43) Pub. Date: Nov. 17, 2011

(54) Method, apparatus and system for improving tuning in receivers

(76) Inventor: Gregory Charles Herlein, San Francisco, CA (US)

(21) Appl. No.: 13/138,262

(22) PCT Filed: Jul. 10, 2009
(86) PCT No.: PCT/US2009/004039

§ 371 Date: Jul. 26, 2011

Related U.S. Application Data
(60) Provisional application No. 61/205,959, filed on Jan. 26, 2009.

(51) Int. Cl. H04N 5/50

(52) U.S. Cl. 348/731; 348/E05.097

(57) ABSTRACT

A method, apparatus and system for reducing a time it takes for a receiver/playout device to start playing content includes providing the receiver on which content is to be played, information identifying the content. In one embodiment, such information can be included as part of a tuning command. For example, in one embodiment, the content to be played can include audio/video content and the information identifying the content can include audio and video codec parameters. The audio and video codec parameters enable the immediate initialization of a decoder of the receiver/playout device, which reduces a tuning time in the receiver. Providing such information eliminates the need for a decoder to parse a plurality of content packets to identify an audio and video type in the content.

### CROSS-REFERENCE TO RELATED APPLICATIONS

This application claims the benefit of U.S. Provisional Application No. 61/205,959, filed on Jan. 26, 2009. This application is also related to U.S. Provisional Application No. 60/921,714, filed on Apr. 4, 2007 in the USPTO and filed as International Patent Application serial no. PCT/US07/013,949, filed on Jun. 13, 2007 in the PCT and claiming priority to the U.S. Patent Provisional Application No. 60/921,714, both entitled “Device Group Control”, which are hereby incorporated by reference in their entireties.

### FIELD OF THE INVENTION

The present invention generally relates to tuning times in receivers and, more particularly, to a method, apparatus and system for improving the tuning times of receivers such as set-top boxes.

### BACKGROUND OF THE INVENTION

When a receiver, such as a set-top box (STB), is tuned to a new stream, for example using either a standard real-time stream protocol (RTSP) redirect or a device group control protocol (DGCP) session description protocol tuning payload described in a commonly owned application, the STB takes a finite period of delay time to begin to play that new stream. That is, in current systems, the data provided to the STB is necessary but not sufficient to allow the STB to play the audio and video as rapidly as possible.

Such a configuration becomes especially problematic if the RTSP profile used is MPEG2 Transport Stream where the Transport Stream can contain any of a variety of devices for coding/decoding audio and/or video content. This leads to the common implementation of buffering the incoming stream and auto-detecting the information in order to configure a decoder correctly. This buffering causes a delay before the audio and video is played.

### SUMMARY OF THE INVENTION

Embodiments of the present invention address the deficiencies of the prior art by providing a method, apparatus and system for reducing a time it takes for a receiver to start playing received content, in one embodiment, from several seconds to a fraction of a second.

In one embodiment of the present invention, a method for reducing a time it takes for a receiver to start playing received content includes providing, with content to be played, information identifying the content, such that a receiver of the content is able to begin playing the content with reduced delay as compared to content received without respective identification information. In such an embodiment, the content can include audio/video content and the information identifying the content can include audio and video codec parameters. In addition, in such embodiments, the information identifying the content can be communicated to a receiver/playout device as part of a tuning command. In various embodiments of the present invention, the content and information identifying the content can be communicated to at least one receiver/playout device using a device group control protocol.

In an alternate embodiment of the present invention, a method for reducing a time it takes for a receiver to start playing received content includes receiving content and information identifying the content and using the received information to initialize a decoder such that the content can be played by a receiver/playout device with reduced delay as compared to content received without respective identification information. In such an embodiment, the information identifying the content can be communicated to a receiver/playout device in a session description protocol data pack.

An alternate embodiment of the present invention includes a computer readable medium including multimedia content recorded thereon and recorded information identifying the multimedia content, such that a receiver/playout device of the multimedia content is able to begin playing the multimedia content with reduced delay as compared to content without respective identification information.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a content distribution system in which various implementations of the present invention can be applied in accordance with an embodiment of the present invention;

FIG. 2 depicts a high level block diagram of a retail advertising network in accordance with an embodiment of the present invention;

FIG. 3 depicts a flow diagram of a prior art technique for receiving and parsing data; and

FIG. 4 depicts a flow diagram of a method for improving tuning of a receiver in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for reducing a time it takes for a receiver to start playing received content. Although the present invention will be described primarily within the context of a retail advertising network environment and a set-top box, the specific embodiments of the present invention should not be treated as limiting the scope of the invention. It will be appreciated by those skilled in the art and informed by the teachings of the present invention that the concepts of the present invention can be advantageously applied in substantially any content distribution environment having various types of receivers.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

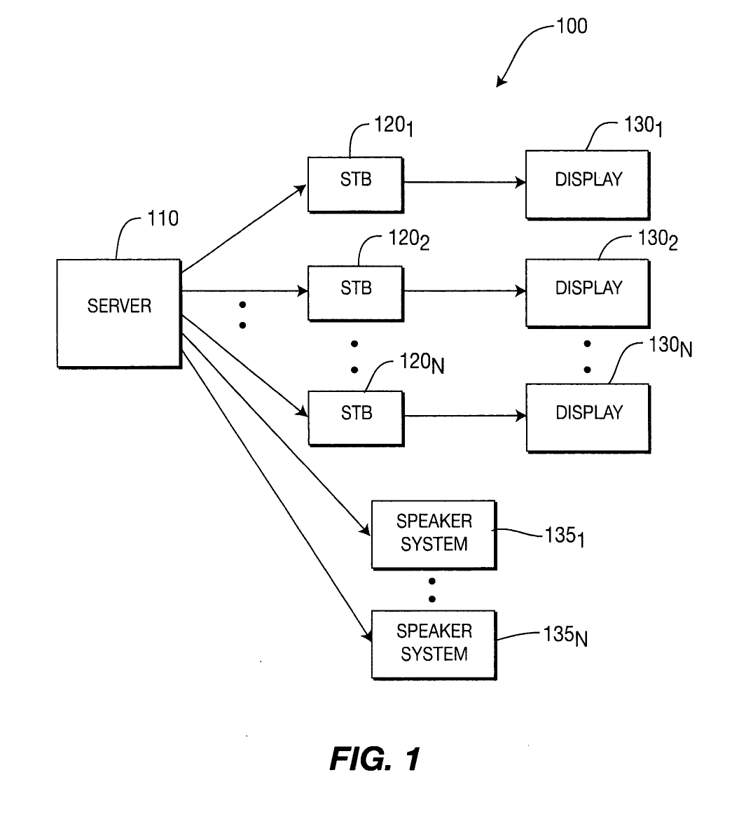

FIG. 1 depicts a high level block diagram of a content distribution system in which various implementations of the present invention can be applied in accordance with an embodiment of the present invention. The content distribution system 100 of FIG. 1 illustratively comprises at least one server 110, a plurality of receiving devices such as tuning/decoding means (illustratively set-top boxes (STBs)) 120₁-120ₙ, and a respective display 130₁-130ₙ for each of the set-top boxes 120₁-120ₙ, and other receiving devices, such as audio output devices (illustratively speaker systems) 135₁-135ₙ. Although in the system 100 of FIG. 1, each of the plurality of set-top boxes 120₁-120ₙ, is illustratively connected to a single, respective display, in alternate embodiments of the present principles, each of the plurality of set-top boxes 120₁-120ₙ, can be connected to more than a single display. In addition, although in the content distribution system 100 of FIG. 1 the tuning/decoding means are illustratively depicted as set-top boxes 120, in alternate embodiments of the present principles, the tuning/decoding means of the present invention can comprise alternate tuning/decoding means such as a tuning/decoding circuit integrated into the displays 130 or other stand alone tuning/decoding devices and the like. Even further, receiving devices of the present invention can include any devices capable of receiving content such as audio, video and/or audio/video content.

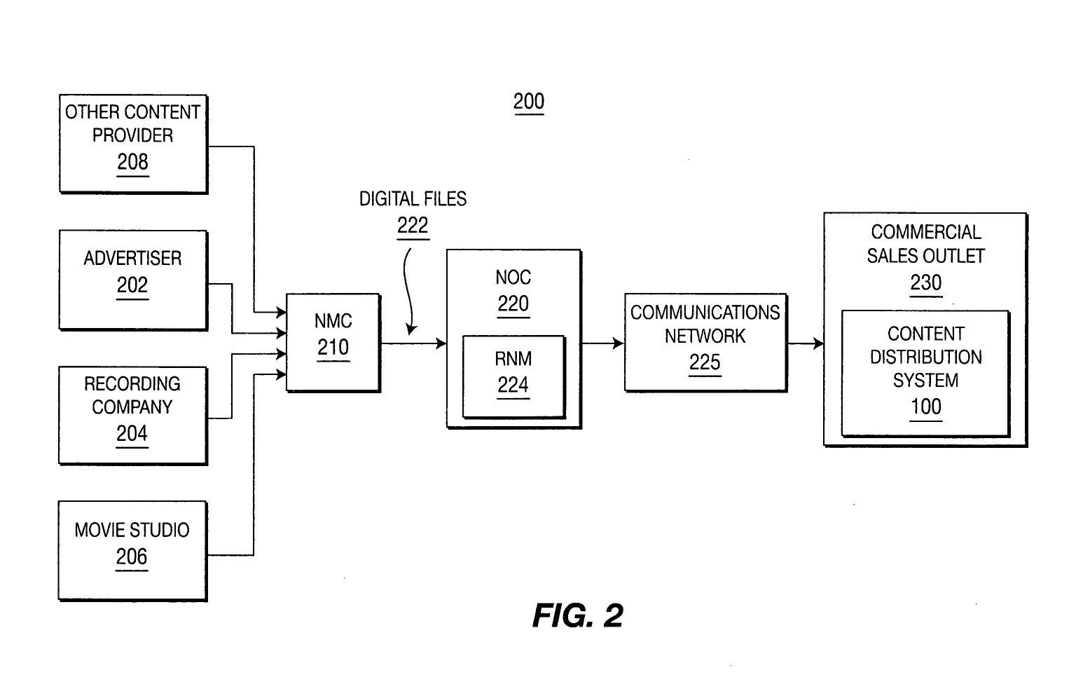

In one embodiment, the content distribution system 100 of FIG. 1 can be a part of a retail advertising network. For example, FIG. 2 depicts a high level block diagram of a retail advertising network for providing retail advertising according to an aspect of the present principles. In the advertising network 200 of FIG. 2, the advertising network 200 and server system 100 employ a combination of software and hardware that provides cataloging, distribution, presentation, and usage tracking of music recordings, home video, product demonstrations, advertising content, and other such content, along with entertainment content, news, and similar consumer informational content in an in-store setting. The content can include content presented in compressed or uncompressed video and audio stream format (e.g., MPEG2, MPEG4/MPEG4 Part 10/AVC-H.264, VC-1, Windows Media, etc.), although the present system should not be limited to using only those formats.

In one embodiment, software for controlling the various elements of the in-store advertising network 200 and the content distribution/server system 100 can include a 32-bit operating system using a windowing environment (e.g., MS-Windows™ or X-Windows™ operating system) and high-performance computing hardware. The advertising network 200 can utilize a distributed architecture and provides centralized content management and distribution control via, in one embodiment, satellite (or other method, e.g., a wide-area network (WAN), the Internet, a series of microwave links, or a similar mechanism) and in-store s.

As depicted in FIG. 2, the content for the retail advertising network 200 and the content distribution system 100 can be provided from an advertiser 202, a recording company 204, a movie studio 206 or other content providers 208. An advertiser 202 can be a product manufacturer, a service provider, an advertising company representing a manufacturer or service provider, or other entity. Advertising content from the advertiser 202 can consist of audiovisual content including commercials, “info-mercials”, product information and product demonstrations, and the like.

A recording company 204 can be a record label, music publisher, licensing/publishing entity (e.g., BMI or ASCAP), individual artist, or other such source of music-related content. The recording company 204 provides audiovisual content such as music clips (short segments of recorded music), music video clips, and the like. The movie studio 206 can be a movie studio, a film production company, a publicist, or other source related to the film industry. The movie studio 106 can provide movie clips, pre-recorded interviews with actors and actresses, movie reviews, “behind-the-scenes” presentations, and similar content.

The other content provider 208 can be any other provider of video, audio or audiovisual content that can be distributed and displayed via, for example, the content distribution system 100 of FIG. 1.

In one embodiment, content is procured via the network management center 210 (NMC) using, for example, traditional recorded media (tapes, CD's, videos, and the like). Content provided to the NMC 210 is compiled into a form suitable for distribution to, for example, the local distribution system 100, which distributes and displays the content at a local site (e.g., within a particular store).

The NMC 210 can digitize the received content and provide it to a Network Operations Center (NOC) 220 in the form of digitized data files 222. It will be noted that data files 222, although referred to in terms of digitized content, can also be streaming audio, streaming video, or other such information. The content compiled and received by the NMC 210 can include commercials, bumpers, graphics, audio and the like. All files are preferably named so that they are uniquely identifiable. More specifically, the NMC 210 creates distribution packs that are targeted to specific sites, such as store locations, and delivered to one or more stores on a scheduled or on-demand basis. The distribution packs, if used, contain content that is intended to either replace or enhance existing content already present on-site (unless the site's system is being initialized for the first time, in which case the packages delivered will form the basis of the site's initial content). Alternatively, the files can be compressed and transferred separately, or a streaming compression program of some type employed.

In the illustrated embodiment of FIG. 2, the NOC 220 includes a Retail Network Manager (RNM) 224 for defining a particular group of servers to be monitored and/or controlled as a unit. That is, in one embodiment of the present invention, servers can be grouped by the RNM 224 according to a Device Group Control Protocol (DGCP) described in a commonly owned Provisional Patent Application Ser. No. 60/921,714, filed on Apr. 4, 2007 in the USPTO and an International Patent Application serial no. PCT/US07/013,949, filed on Jun. 13, 2007 in the PCT and electing the U.S., both entitled “Device Group Control”, which are herein incorporated by reference in their entireties.

That is, in accordance with the Device Group Control Protocol, each server can be configured to belong to at least one group—itself—and can also belong to many other groups. As such, commands or requests can be targeted by group—which can contain one or a plurality of servers. Each server of a group will, as such, transmit and receive using the same broadcast or multicast channel. In various embodiments of the above described invention, servers can support being members of as many groups as desired. In addition, servers can be configured to be members of or not members of groups either by using the protocol or by external means, such as configuration files or other transactions such as (Simple Network Management Protocol) SNMP or web configuration pages. In various embodiments of the present invention, servers can be grouped according to a commonality such as all stores within a certain zip code, all stores within a time zone, all stores within a particular state, all stores within a particular region, a demographic characteristic and the like. Groups of systems can be assigned a unique identifier and then communicated with, monitored and controlled as a unit.

In the retail advertising network 200 of FIG. 2, the NOC 220 communicates digitized data files 222 to each associated server/content distribution system 100 at a commercial sales outlet 230 via a communications network 225. Each server 100 includes a group identifier unit 102 configured for enabling the server to examine an incoming message (e.g., from NOC 220) to determine if the server belongs to a target group to which the message applies.

In accordance with various embodiment of the present invention, the communications network 225 can be implemented in any one of several technologies. For example, in one embodiment of the present invention, the communications network 225 can comprise a satellite link (satellite IP network) to distribute digitized data files 222 to each applicable server system 100 of, for example, commercial sales outlets 230. Such a configuration advantageously enables content to be distributed by multicasting the content to various locations simultaneously. Alternatively, the Internet can be used to both distribute audiovisual content to and allow feedback from commercial sales outlets 230. Other techniques and configurations for implementing the communications network 225, such as using leased lines, a microwave network, or other such mechanisms can also be used in accordance with alternate embodiments of the present invention.

At the local level (e.g., in-store), the server 110 of the content distribution system 100 is capable of receiving content (e.g., distribution packs) and, accordingly, distribute them in-store to the various receivers such as the set-top boxes 120 and displays 130 and the speaker systems 135. That is, at the content distribution system 100, content is received and configured for streaming. The streaming can be performed by one or more servers configured to act together or in concert. The streaming content can include content configured for various different locations or products throughout the sales outlet 230 (e.g., a store). For example, respective set-top boxes 120 and displays 130 and various speaker systems 135 can be located at specific locations throughout the sales outlet 230 and respectively configured to display content and broadcast audio pertaining to products located within a predetermined distance from the location of each respective set-top box and display.

The server 110 of the content distribution system 100 receives content and creates various different streams (e.g., content channels) of text, audio, video and/or audio/video to be communicated to the various receivers throughout the store. The streams can be individual channels of modulated audio, video and/or audio/video onto a radio frequency distribution or transmitted as data flows within a unicast or multicast internet protocol (IP) network. These streams can originate from one or more servers under the same logical set of control software.

For example, in one embodiment of the present invention a server of the present invention, such as the server 110 of the content distribution system 100 of FIG. 1, can communicate received streams according to a Device Group Control Protocol described in a commonly owned Provisional Patent Application serial no. 60/921,714, filed on Apr. 4, 2007 in the USPTO and also filed as an International Patent Application serial no. PCT/US07/013,949, filed on Jun. 13, 2007 in the PCT and electing the U.S., both entitled “Device Group Control”, which are hereby incorporated by reference in their entireties.

That is in accordance with the Device Group Control Protocol, a server can be configured to communicate information according to the Device Group Control Protocol. Using such a protocol, a receiver can be configured to belong to at least one group—itself—and can also belong to many other groups. As such, commands, requests or communication of content can be targeted by group—which can contain one or a plurality of devices. Each device of a group will, as such, transmit and receive using the same broadcast or multicast channel. In various embodiments of the above described invention, devices can support being members of as many groups as desired. In addition, devices can be configured to be members of or not members of groups either by using the protocol or by external means, such as configuration files or other transactions such as (Simple Network Management Protocol) SNMP or web configuration pages. In addition, some applications of the above described invention find it highly desirable to also pre-configure group membership.

In one embodiment using such a protocol, the stock DGCP payload delivers a Session Description Protocol (SDP) data block to a set-top box (STB) using a format similar to the real-time stream protocol (RTSP) DESCRIBE response does. SDP is defined by the IETF (http://tools.ietf.orq/html/rfc2327).

Such a data block may include the following format:
c=IN IP4 233.192.0.101
a=control:rtsp://169.254.1.1/view0
a=type:scheduled
m=video 49162 RTP/AVP 33
a=fmtp:33 program_number=1
a=framerate:29.97
a=orient:portrait.
   The data described above includes:
IP address and port (233.192.0.101/49162)
Controlling RTSP URL (rtsp://169.254.1.1/view0)
Stream type (video)
RTP profile type (33—MPEG2 Transport Stream)
Video frame rate (29.97)

Video orientation (portrait).

However, such a data block fails to include information regarding:
Video resolution
Video aspect ratio (4:3 or 16:9 or other)
Video codec
Video bit rate
Audio codec
Audio bit rate
   In such applications using, for example, MPEG2 transport streams, the missing information is critical. In one communication the video codec may be MPEG2, however in another communication the video codec may be H.264 (MPEG4 part 10). In addition, the audio codec may include MPEG audio, but alternative may include Dolby AC3.

As such and in accordance with various embodiments of the present invention, to enable the smallest possible delay when communicating with a receiver, such as a STB or a speaker, at least some of the above described information, or more, should be communicated to the receiver as part of the tuning command. More specifically, in accordance with various embodiments of the present invention, by communicating additional information to a receiver, the time it takes to tune to a new stream can be shortened.

In one specific embodiment of the present invention, Session Description Protocol (SDP) extensions are used to convey data and communicate with a receiver. In such an embodiment, using SDP can include media attributes including the following:
a=vcodec:mpeg2-in-mpeg2ts
a=vcodecrate:19.39 mbps
a=vcodecaspect:16×9
a=vcodecresolution:1920×1200
a=acodec:ac3
a=acodecrate:200 kbps
a=acodecchannels:5.1

In an alternate embodiment of the present invention, a binary DGCP payload would have similar information as described above defined in bit fields.

For example, in current system architectures, the current technique is to begin to acquire the transport stream and then parse the transport stream, for example an MPEG transport stream, to detect video and audio codecs and the codec parameters. This technique can take from a half second to several seconds. The various embodiments of the present invention advantageously reduce the tuning time as compared to previous techniques.

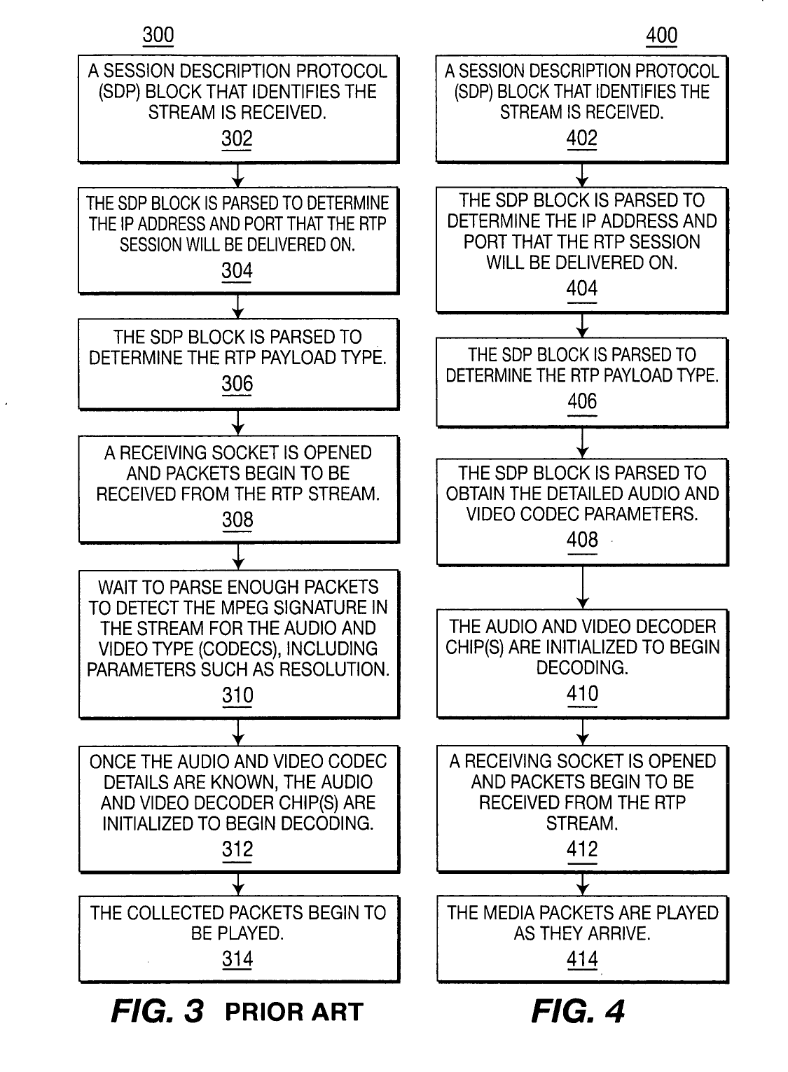

To demonstrate the advantage over prior art techniques, first a flow diagram of a prior art method for receiving and parsing data is described below; then of a method for improving tuning of a receiver in accordance with an embodiment of the present invention is described. FIG. 3 depicts a flow diagram of a prior art technique for receiving and parsing data. The method 300 begins at step 302 at which, using RTSP or DGCP, the Session Description Protocol (SDP) block that identifies the stream is received. An example of such an SDP includes:
c=IN IP4 233.192.0.101
a=control:rtsp://169.254.1.1/view0
a=type:scheduled
m=video 49162 RTP/AVP 33
a=fmtp:33 program_number=1
a=framerate:29.97
a=orient:portrait.
   The method 300 then proceeds to step 304.

At step 304, the SDP block is parsed to determine the IP address and port that the RTP session will be delivered on. In the example above, the IP address is parsed as 233.192.0.101 port 49162. The method 300 then proceeds to step 306.

At step 306, the SDP block is parsed to determine the RTP payload type. In the example above, the payload type is parsed an RTP/AVT type 33, which is an MPEG2 transport stream. The method 300 then proceeds to step 308.

At step 308, a receiving socket is opened and packets begin to be received from that RTP stream. The method then proceeds to step 310.

At step 310, the method waits to parse enough packets to detect the MPEG signature in the stream for the audio and video type, including parameters such as resolution. Once those codec details are known, the method 300 proceeds to step 312.

At step 312, the audio and video decoder chip(s) are initialized to begin decoding. The method 300 then proceeds to step 314.

At step 314, the collected packets begin to be played. Note that these packets may have been buffered from the first moment of reception. During this time, the decoder chips will decode the compressed bit stream and turn it into audio and video for output to playout devices, such as displays and speakers. In such a method 300 of the prior art, the delay from the moment of reception of the SDP to the moment video is seen and audio is heard can be from a partial second to several seconds, depending on how much MPEG transport stream must be parsed to obtain the data needed to initialize the decoder chips.

FIG. 4 depicts a flow diagram of a method 400 for improving tuning of a receiver in accordance with an embodiment of the present invention. The method 400 begins at step 402 at which, using RTSP or DGCP, the Session Description Protocol (SDP) block that identifies the stream is received. An example of such an SDP includes:
c=IN IP4 233.192.0.101
a=control:rtsp://169.254.1.1/view0
a=type:scheduled
m=video 49162 RTP/AVP 33
a=fmtp:33 program_number=1
a=framerate:29.97
a=orient:portrait
a=vcodec:mpeg2-in-mpeg2ts
a=vcodecrate:19.39 mbps
a=vcodecaspect:16×9
a=vcodecresolution:1920×1200
a=acodec:ac3
a=acodecrate:200 kbps
a=acodecchannels:5.1.
   As clear from the example SDP described and presented above, in various embodiments of the present invention, additional data is provided up front to allow the immediate initialization of the decoder chips. The method 400 then proceeds to step 404.

At step 404, the SDP block is parsed to determine the IP address and port that the RTP session will be delivered on. In the example above the IP address is 233.192.0.101 and port is 49162. The method 400 proceeds to step 406.

At step 406, the SDP block is parsed to determine the RTP payload type. In the example above, an RTP/AVT type is 33, which is an MPEG2 transport stream. The method 400 proceeds to step 408.

At step 408, the SDP block is parsed to obtain the detailed audio and video codec parameters. In various embodiments of the present invention, the additional codec information enables the immediate initialization of the decoder chips, which reduces the tuning time in receivers. That is, in contrast to the prior art method described above in which a receiver waits to parse enough packets to detect the MPEG signature in the stream for the audio and video type, including parameters such as resolution, in embodiments of the present invention, the SDP block is parsed to obtain the detailed audio and video codec parameters, which enables the immediate initialization of the decoder chips. After parsing the SDP block to obtain the detailed audio and video codec parameters, the method 400 proceeds to step 410.

At step 410, the audio and video decoder chip(s) are initialized to begin decoding. The method 400 then proceeds to step 412.

At step 412, a receiving socket is opened and packets begin to be received from that RTP stream. The method then proceeds to step 414.

At step 414, the media packets are played as they arrive. The decoder chips decode the compressed bit stream as audio and video for output to playout devices such as displays and speakers. In accordance with embodiments of the present invention, the delay from the moment of reception of the SDP to the moment video is seen and audio is heard is reduced as compared with the above described prior art method 300 at least because there exists no waiting to parse the MPEG transport stream.

In one embodiment of the present invention, information to be used by a receiver/playout device for identifying content (e.g., audio and/or video content) in accordance with the present invention, can be communicated to a receiver/playout device from a content server such as the server 110 of the content distribution system 100 of FIG. 1, and/or the NOC 220 and/or the NMC 210 of the retail advertising network 200 of FIG. 2. That is, in one embodiment of the present invention, information identifying content to be distributed can stored in a memory (not shown) of a server of the present invention and can be communicated with the content and/or as a part of a tuning command to a receiver. That is, a server of the present invention can include a processor (not shown) for performing the various operating functions of a server, as described above, and can further include a memory for storing content and/or information identifying the content as described above and in accordance with the various embodiments of the present invention described herein.

Having described various embodiments for a method, apparatus and system for reducing a time it takes for a receiver to start playing received content (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method, comprising the steps of:
providing, with content, information identifying said content, such that a receiver of said content is able to begin playing said content with reduced delay as compared to content received without respective identification information.

2. The method of claim 1, wherein said content includes audio/video content and said information identifying said content includes audio and video codec parameters.

3. The method of claim 2, wherein said codec parameters enable the initialization of a decoder, which reduces a tuning time in a receiver.

4. The method of claim 1, wherein said information identifying said content is communicated to a receiver in a session description protocol data pack.

5. The method of claim 1, wherein said information identifying said content eliminates the need for a decoder to parse a plurality of content packets to identify an audio and video type in said content.

6. The method of claim 1, wherein said content and information identifying said content is communicated to at least one receiver using a device group control protocol.

7. The method of claim 1, wherein said and information identifying said content is communicated to a receiver as part of a tuning command.

8. A method, comprising the steps of:
receiving information identifying content to be played; and
using said received information to identify said content for initializing a decoder such that said content can be played with reduced delay as compared to content received without respective identification information.

9. The method of claim 8, wherein said content includes audio/video content and said information identifying said content includes audio and video codec parameters.

10. The method of claim 8, wherein said information identifying said content is communicated to a playout device in a session description protocol data pack.

11. The method of claim 8, wherein said information identifying said content eliminates the need for a decoder to parse a plurality of content packets to identify an audio and video type in said content.

12. The method of claim 8, wherein said content and information identifying said content is communicated to at least one playout device using a device group control protocol.

13. The method of claim 8, wherein said and information identifying said content is received as part of a tuning command.

14. The method of claim 8, further comprising:
opening a receiving socket to receive the content; and
playing the content as the content is received.

15. A computer readable medium, comprising:
multimedia content recorded thereon; and
recorded information identifying said multimedia content, such that a playout device of said multimedia content is able to begin playing said multimedia content with reduced delay as compared to content without respective identification information.

16. The computer readable medium of claim 15, wherein said content includes audio/video content and said information identifying said content includes audio and video codec parameters.
